(19) United States
(12) Patent Application Publication
(10) Pub. No.: US 2023/0018772 A1
(43) Pub. Date: Jan. 19, 2023

(54) ROOT-CAUSING SAAS ENDPOINTS FOR NETWORK ISSUES IN APPLICATION-DRIVEN PREDICTIVE ROUTING

(71) Applicant: Cisco Technology, Inc., San Jose, CA (US)

(72) Inventors: Vinay Kumar Kolar, San Jose, CA (US); Jean-Philippe VASSEUR, Saint Martin d’Uriage (FR); Grégory MERMOUD, Venthône (CH); Pierre-André SAVALLE, Rueil-Malmaison (FR)

(21) Appl. No.: 17/379,586

(22) Filed: Jul. 19, 2021

(51) Int. Cl. H04L 12/725; H04L 12/24

(52) U.S. Cl. CPC H04L 45/306; H04L 41/0654; H04L 41/0631

(57) ABSTRACT

In one embodiment, a device obtains telemetry data for network paths to a plurality of servers for an online application. The telemetry data includes application experience metrics based on feedback provided by users of the online application. The device decomposes the telemetry data for the network paths from different vantage points. The device also identifies, using the decomposed telemetry data, a particular endpoint of the online application as a cause of application experience degradation for the online application. The device provides an alert indicative of the particular endpoint of the online application being the cause of quality of experience degradation for the online application.

### TECHNICAL FIELD

The present disclosure relates generally to computer networks, and, more particularly, to root-causing software as a service (SaaS) endpoints for network issues in application-driven predictive routing.

### BACKGROUND

Software as a service (SaaS) applications are often deployed across multiple servers and geographic regions, to provide best connectivity to the clients who connect to the application. These applications are automatically scaled out into various servers on data centers across the world. Hence, the application experience of a user of a SaaS application depends on a number of different points of failure: the endpoint device of the user, their Local Area Network (LAN), the core. Internet, the SaaS endpoint(s)/data center(s), etc. Accordingly, troubleshooting poor SaaS application experience to trigger corrective measures (e.g., rerouting the application traffic) with such a wide array of possible components interacting with each other is challenging.

With the recent evolution of machine learning, predictive failure detection and proactive routing for SaaS applications now becomes possible through the use of machine learning techniques. For instance, modeling the delay, jitter, packet loss, etc. for a network path can be used to predict when the current path will result in poor application quality and proactively reroute the traffic of the application onto another path, beforehand. However, if the poor application quality is caused by the SaaS endpoint itself (e.g., a particular server or data center), changing the intermediate paths to that endpoint will have no actual effect on the application experience.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIGS. 4A-4B illustrate example software defined network (SDN) implementations;

FIG. 5 illustrates an example architecture for determining the root cause of software as a service (SaaS) application performance degradations;

FIG. 6 illustrates an example of SaaS network paths from different vantage points;

FIGS. 7A-7B illustrates example plots of application experience across SaaS data centers; and

FIG. 8 illustrates an example simplified procedure for identifying a SaaS endpoint as the root-cause of degraded application performance.

### DESCRIPTION OF EXAMPLE EMBODIMENTS

### Overview

According to one or more embodiments of the disclosure, a device obtains telemetry data for network paths to a plurality of servers for an online application. The telemetry data includes application experience metrics based on feedback provided by users of the online application. The device decomposes the telemetry data for the network paths from different vantage points. The device also identifies, using the decomposed telemetry data, a particular endpoint of the online application as a cause of application experience degradation for the online application. The device provides an alert indicative of the particular endpoint of the online application being the cause of quality of experience degradation for the online application.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

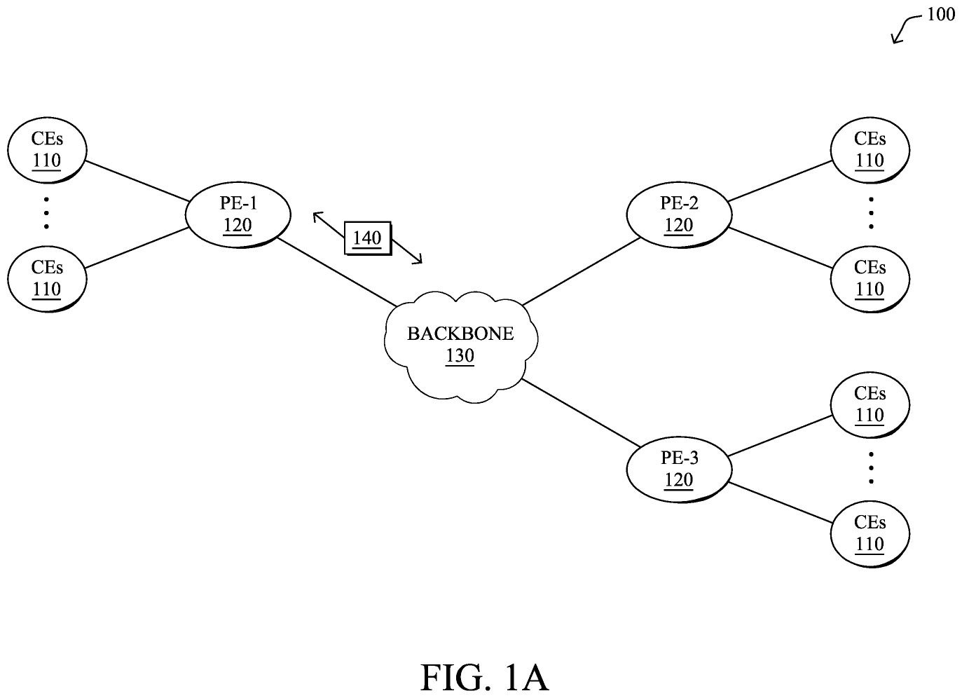

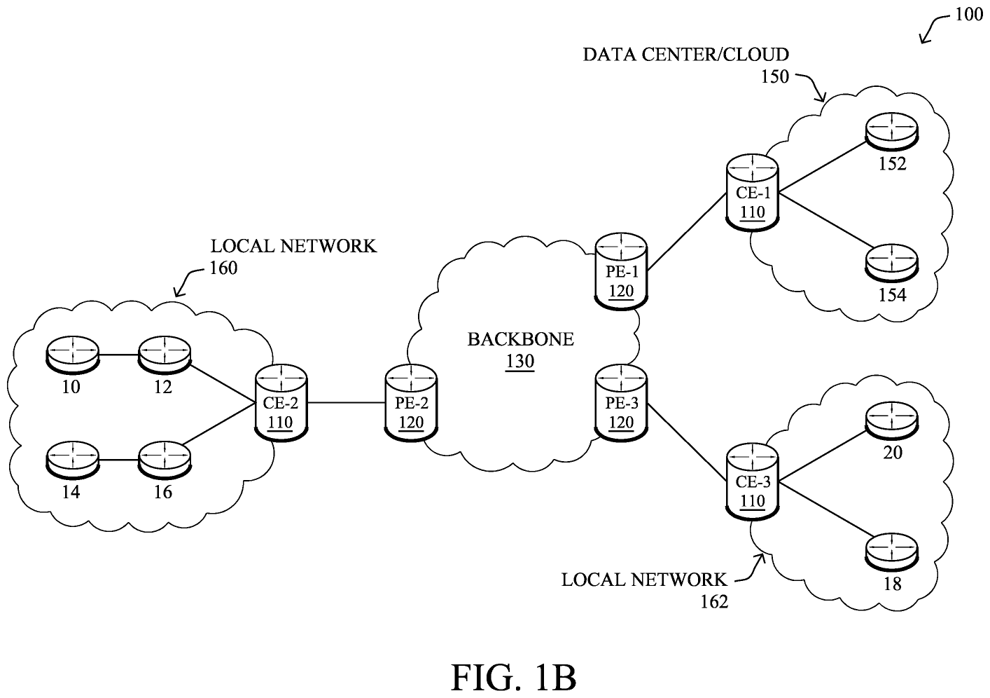

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

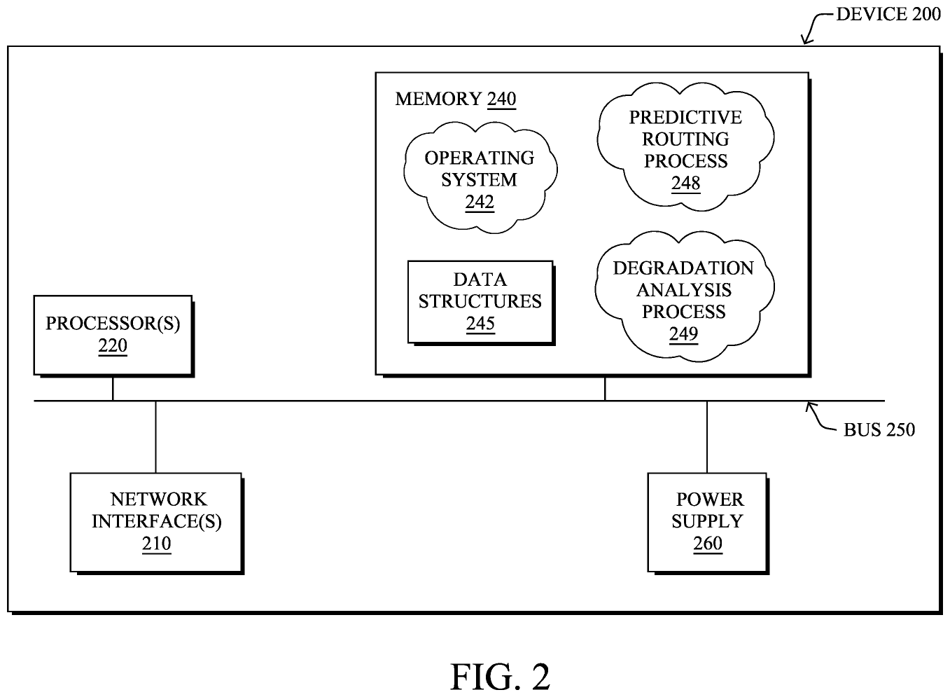

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a predictive routing process 248 and/or a degradation analysis process 249, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, predictive routing process 248 contains computer executable instructions executed by the processor 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

In various embodiments, as detailed further below, predictive routing process 248 and/or a degradation analysis process 249 may include computer executable instructions that, when executed by processor(s) 220, cause device 200 to perform the techniques described herein. To do so, in some embodiments, predictive routing process 248 and/or a degradation analysis process 249 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, predictive routing process 248 and/or a degradation analysis process 249 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that predictive routing process 248 and/or a degradation analysis process 249 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software as a service (SaaS) is having a dramatic impact of the overall Internet due to the extreme virtualization of services and shift of traffic load in many large enterprises. Consequently, a branch office or a campus can trigger massive loads on the network.

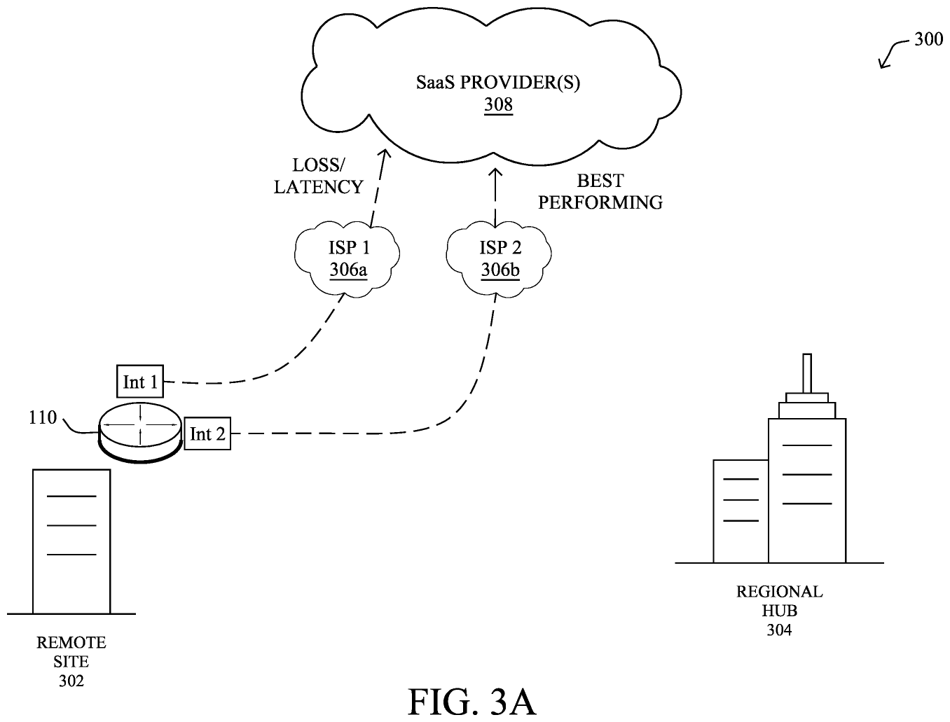

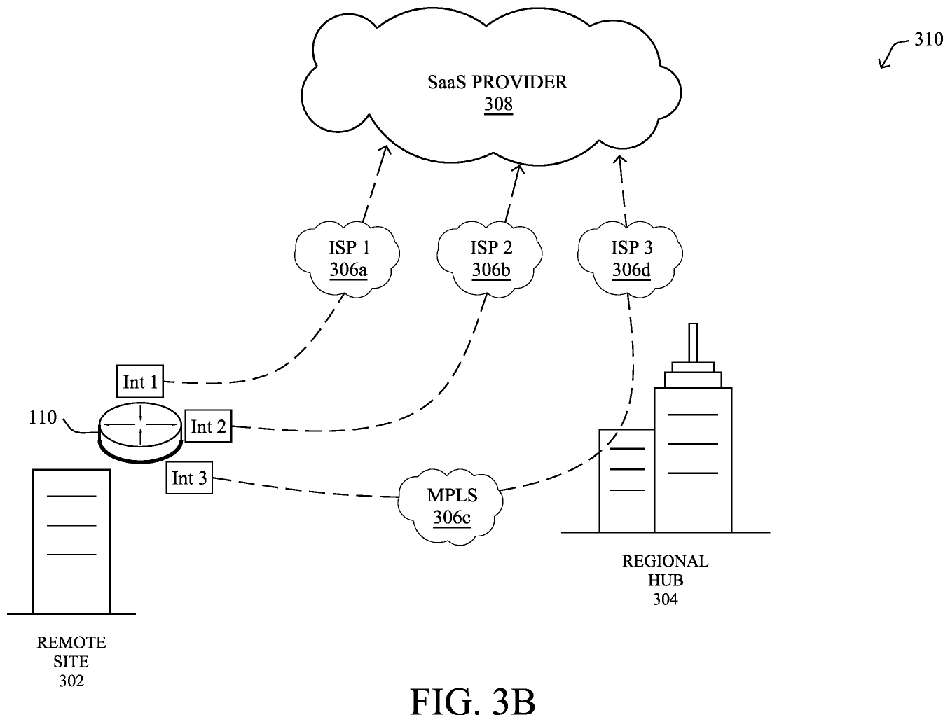

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

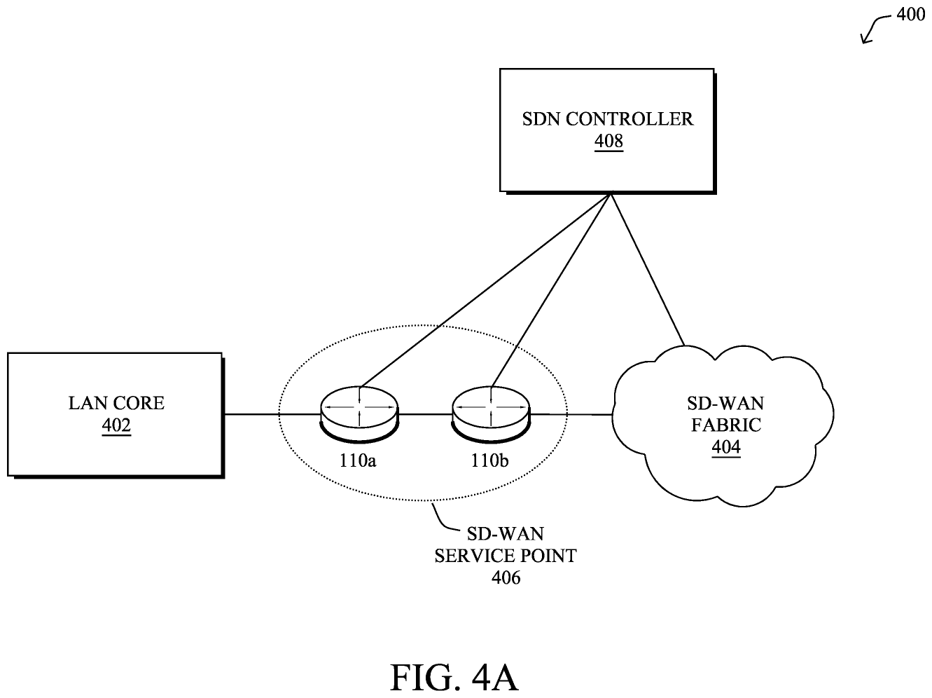

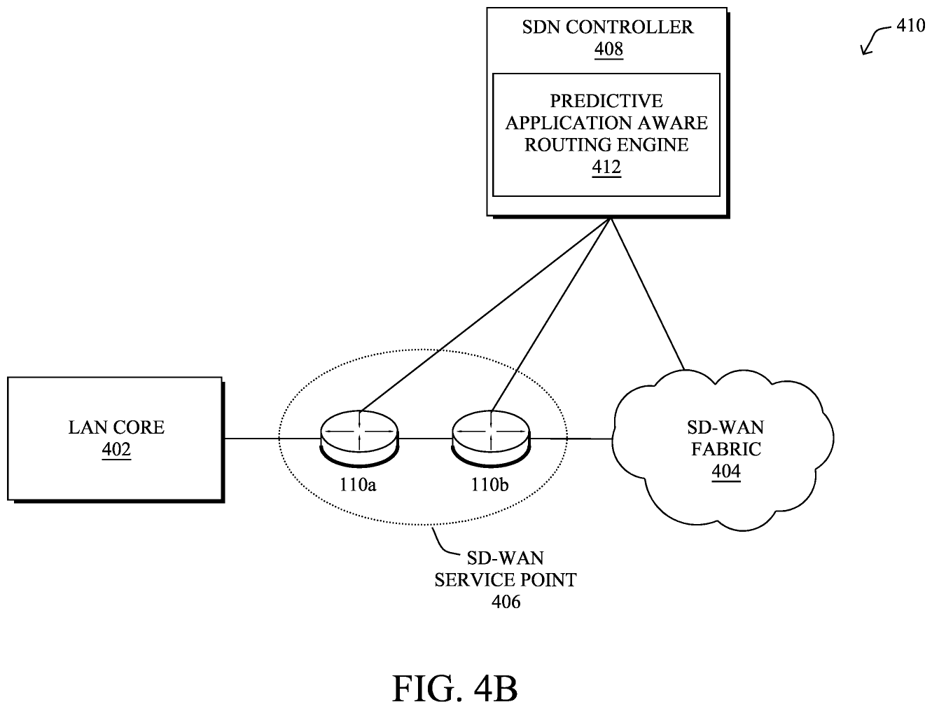

FIG. 4A illustrates an example SDN implementation 400, according to various embodiments. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service, typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various embodiments, application aware routing usually refers to the ability to rout traffic so as to satisfy the requirements of the application, as opposed to exclusively relying on the (constrained) shortest path to reach a destination IP address. Various attempts have been made to extend the notion of routing, CSPF, link state routing protocols (ISIS, OSPF, etc.) using various metrics (e.g., Multi-topology Routing) where each metric would reflect a different path attribute (e.g., delay, loss, latency, etc.), but each time with a static metric. At best, current approaches rely on SLA templates specifying the application requirements so as for a given path (e.g., a tunnel) to be “eligible” to carry traffic for the application. In turn, application SLAs are checked using regular probing. Other solutions compute a metric reflecting a particular network characteristic (e.g., delay, throughput, etc.) and then selecting the supposed ‘best path,’ according to the metric.

The term ‘SLA failure’ refers to a situation in which the SLA for a given application, often expressed as a function of delay, loss, or jitter, is not satisfied by the current network path for the traffic of a given application. This leads to poor QoE from the standpoint of the users of the application. Modern SaaS solutions like Viptela, CloudonRamp SaaS, and the like, allow for the computation of per application QoE by sending HyperText Transfer Protocol (HTTP) probes along various paths from a branch office and then route the application's traffic along a path having the best QoE for the application. At a first sight, such an approach may solve many problems. Unfortunately, though, there are several shortcomings to this approach:
The SLA for the application is ‘guessed,’ using static thresholds.
Routing is still entirely reactive: decisions are made using probes that reflect the status of a path at a given time, in contrast with the notion of an informed decision.
SLA failures are very common in the Internet and a good proportion of them could be avoided (e.g., using an alternate path), if predicted in advance.

In various embodiments, the techniques herein allow for a predictive application aware routing engine to be deployed, such as in the cloud, to control routing decisions in a network. For instance, the predictive application aware routing engine may be implemented as part of an SDN controller (e.g., SDN controller 408) or other supervisory service, or may operate in conjunction therewith. For instance, FIG. 4B illustrates an example 410 in which SDN controller 408 includes a predictive application aware routing engine 412 (e.g., through execution of predictive routing process 248). Further embodiments provide for predictive application aware routing engine 412 to be hosted on a router 110 or at any other location in the network.

During execution, predictive application aware routing engine 412 makes use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, predictive application aware routing engine 412 may compute a variety of models to understand application requirements, and predictably route traffic over private networks and/or the Internet, thus optimizing the application experience while drastically reducing SLA failures and downtimes.

In other words, predictive application aware routing engine 412 may first predict SLA violations in the network that could affect the QoE of an application (e.g., due to spikes of packet loss or delay, sudden decreases in bandwidth, etc.). In turn, predictive application aware routing engine 412 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one embodiment. In general, routing configuration changes are also referred to herein as routing “patches,” which are typically temporary in nature (e.g., active for a specified period of time) and may also be application-specific (e.g., for traffic of one or more specified applications).

As noted above, SaaS applications are often deployed across multiple servers and geographic regions, to provide best connectivity to the clients who connect to the application. These applications are automatically scaled out into various servers on data centers across the world. Hence, the application experience of a user of a SaaS application depends on a number of different points of failure: the endpoint device of the user, their Local Area. Network (LAN), the core Internet, the SaaS endpoint(s)/data center(s), etc.

With respect to application-aware predictive routing, such as by predictive application aware routing engine 412, a key issue arises when the SaaS endpoint itself is the cause of the performance degradation of the application. In such a case, any attempt by predictive application aware routing engine 412 to reroute the application traffic via different paths to the offending SaaS endpoint will still result in degraded application experience.

### Root-Causing SaaS Endpoints for Network Issues in Application-Driven Predictive Routing

The techniques herein introduce mechanism to detect when the root-cause for bad application experience is the SaaS endpoint itself, such as a particular data center or server. In some aspects, the techniques herein introduce data collection mechanisms to obtain the data needed for such a determination by observing the application experience across multiple vantage points such as cities, service providers (SPs), and/or SaaS endpoints. In further aspects, the techniques herein also introduce mechanisms to mitigate issues by routing traffic to different SaaS endpoints predicted to offer better application experience. Doing so helps to a.) avoid network troubleshooting when the source of the problem is the SaaS infrastructure itself, and b.) dynamically redirect to SaaS endpoints that offer better application experience.

Illustratively, the techniques described herein may be performed by hardware, software, and/or firmware, such as in accordance with degradation analysis process 249, which may include computer executable instructions executed by the processor 220 (or independent processor of interfaces 210) to perform functions relating to the techniques described herein, in conjunction with predictive routing process 248.

Specifically, according to various embodiments, a device obtains telemetry data for network paths to a plurality of servers for an online application. The telemetry data includes application experience metrics based on feedback provided by users of the online application. The device decomposes the telemetry data for the network paths from different vantage points. The device also identifies, using the decomposed telemetry data, a particular endpoint of the online application as a cause of application experience degradation for the online application. The device provides an alert indicative of the particular endpoint of the online application being the cause of quality of experience degradation for the online application.

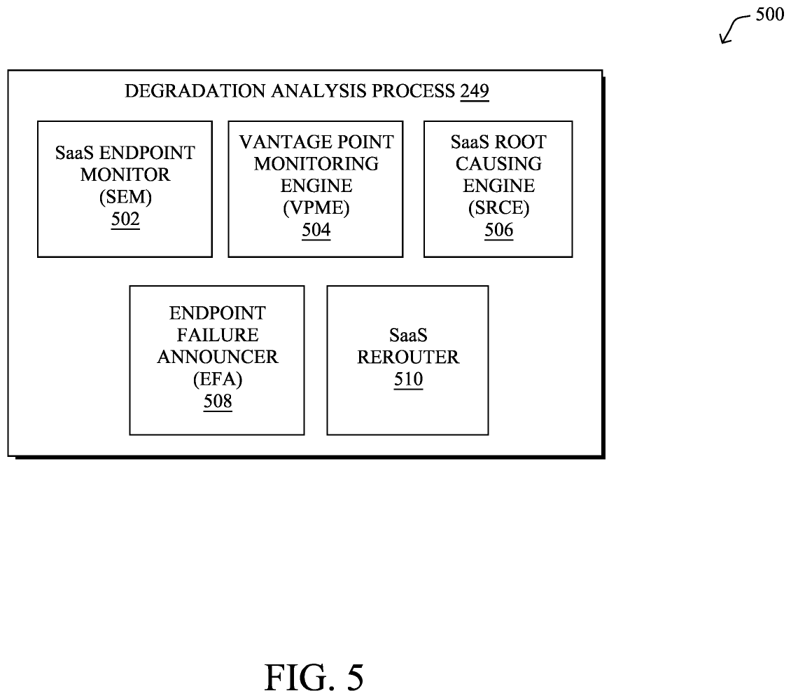

Operationally, FIG. 5 illustrates an example architecture 500 for determining the root cause of software as a service (SaaS) application performance degradations, according to various embodiments. At the core of architecture 500 is degradation analysis process 249, which may be executed by a controller for a network or another device in communication therewith. For instance, degradation analysis process 249 may be executed by a controller for a network (e.g., SDN controller 408 in FIGS. 4A-4B), a particular networking device in the network (e.g., a router, etc.), another device or service in communication therewith, or the like, to provide a supervisory service to the network. More specifically, degradation analysis process 249 may operate in conjunction with a predictive application aware routing engine, such as predictive application aware routing engine 412, or directed implemented as a component thereof, in some embodiments.

As shown, degradation analysis process 249 may include any or all of the following components: a SaaS endpoint monitor (SEM) 502, vantage point monitoring engine (VPME) 504, a SaaS root causing engine (SRCE) 506, an endpoint failure announcer (EFA) 508, and/or a SaaS rerouter 510. As would be appreciated, the functionalities of these components may be combined or omitted, as desired. In addition, these components may be implemented on a singular device or in a distributed manner, in which case the combination of executing devices can be viewed as their own singular device for purposes of executing degradation analysis process 249.

During execution, SEM 502 is responsible for responsible for monitoring the connectivity to SaaS endpoints from different networks and service providers. In addition, SEM 502 may also obtain data from each router interface to different SaaS endpoints.

For instance, SEM 502 may be responsible for responsible for monitoring the connectivity and application experiences from a given branch office or SP in a city (or other geographic area) to all of the observed SaaS endpoints for a given SaaS application. To do so, SEM 502 may obtain application experience metrics indicative of the QoE of the SaaS application for its various users. For instance, SEM 502 may leverage an application experience ingestion application programming interface (API) with the SaaS application provider. In turn, the SaaS provider may publish data about the application experience to SEM 502, periodically (e.g., once every ten minutes), on demand, or at any other time. In other cases, SEM 502 may first request application experience metrics from the SaaS application.

A sample set of application experience metrics is as follows:
Application Name
Session ID
Endpoint ID: Server Name
Data center ID: data center to which the server belongs
Time Period
Application Experience (e.g., a score from 1-100, discrete categories such as {good, bad, no-opinion}, etc.)

In other words, the application experience metrics may be user-specified during or after their use of the SaaS application. For instance, a web conferencing application may ask the attendees of a virtual meeting to rate their experience on a scale from 1-5, 1-10, 1-100, etc., on conclusion of the meeting.

Similarly, SEM 502 may also obtain network performance metrics regarding the connections between the clients and the SaaS servers, either directly from the SaaS application or from the networking devices that supported the connections between the clients and the SaaS endpoints. For instance, network performance metrics may include any or all of the following:
Loss
Latency
Jitter
Bitrate

As would be appreciated, the above metrics may be combined into a singular report with application experience metrics, as desired. Regardless, application experience metrics may be collected for the clients of the SaaS application and the SaaS endpoints for their connections over time.

In another embodiment, application experience metrics and/or network performance metrics may include aggregate metrics across sessions/connections, as opposed to being for each session/connection, such as for all of the traffic egressing from a given router or a subset of routers. In such cases, usually the distribution of network metrics network performance metrics (instead of one value) may be provided. This is important to ensure that the data contains both the average performance of sessions, but also the performance for extreme sessions, which may be rare but still of interest. The aggregate metrics may also indicate the number of requests that were made from the given router to the given endpoint.

In a further embodiment, SEM 502 may initiate the collection of network performance metrics 612, such as by probing the SaaS endpoints with Layer 7 HTTP pings, to monitor the network metrics (e.g., loss, latency, jitter, etc.) over time.

Vantage point monitoring engine (VPME) 504 is responsible for monitoring the health of SaaS endpoints (e.g., data centers or servers), and root-causing application experience issues with those endpoints. To do so, VPME 504 may collate the views of the application experience across different vantage points. Each vantage point can be defined as one measurable point in the path which might be the cause for degraded application experience.

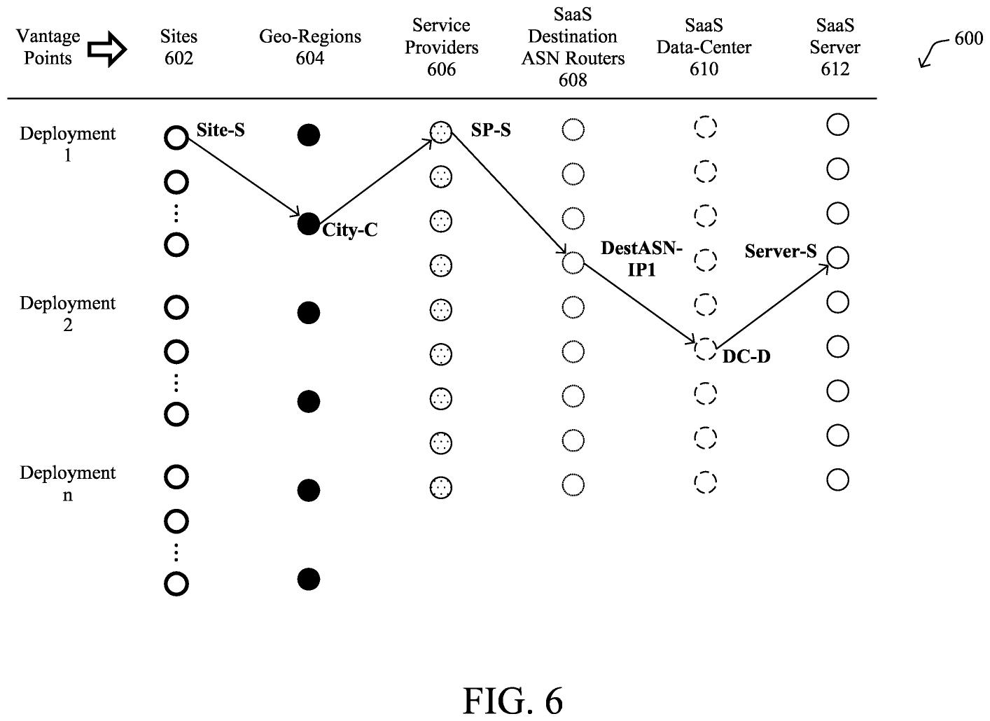

More specifically, in one embodiment, VPME 504 may decompose each path from a router to a SaaS from different vantage points. For example, FIG. 6 illustrates an example 600 showing SaaS network paths from different vantage points. Here, in various embodiments, these vantage points may include any or all of the following:
Client Sites 602: This information is readily given by examining the application flows on the edge routers.
Geo-Regions 604: This can be either inferred from the router locations or by mapping the public-IP of a router to a IP-to-location database such as ip2loc or Max-Mind.
Service Providers 606: This information can also be obtained by mapping the public-IP to SP by using an IP-to-location database. It might also be over-ridden by an administrator specifying the IP for a given interface of the router.
SaaS Destination ASN IP 608: This information can be obtained by running trace-routes or other path-tracing tools (e.g., ThousandEyes), to obtain the final autonomous system number (ASN) before hitting the SaaS data center. The IP address of the router within the ASN can then be recorded.
SaaS Data Centers 610: This information can be obtained from the SaaS provider. For example, a particular SaaS provider may specify a mapping of IP addresses and the data centers in which these servers are present. In other instances, this information can be inferred from path tracing.
SaaS Servers 612: This is the final server IP that is reached by the application. This can be directly noted from the Netflow or other telemetry records at the edge router.

Thus, any given path between a client site and a SaaS server may be assessed from different vantage points. For instance, in the case of FIG. 6, one possible path may extend from Site-S to City-C, to SP-S, to DestASN-IP1, to DC-D, to Server-S.

According to various embodiments, VPME 504 may compute the distribution of application experience metrics for each time-period (e.g., 1 hour) and for each vantage point. The resulting time-series of distributions can then be examined to determine the probable cause of bad application experience.

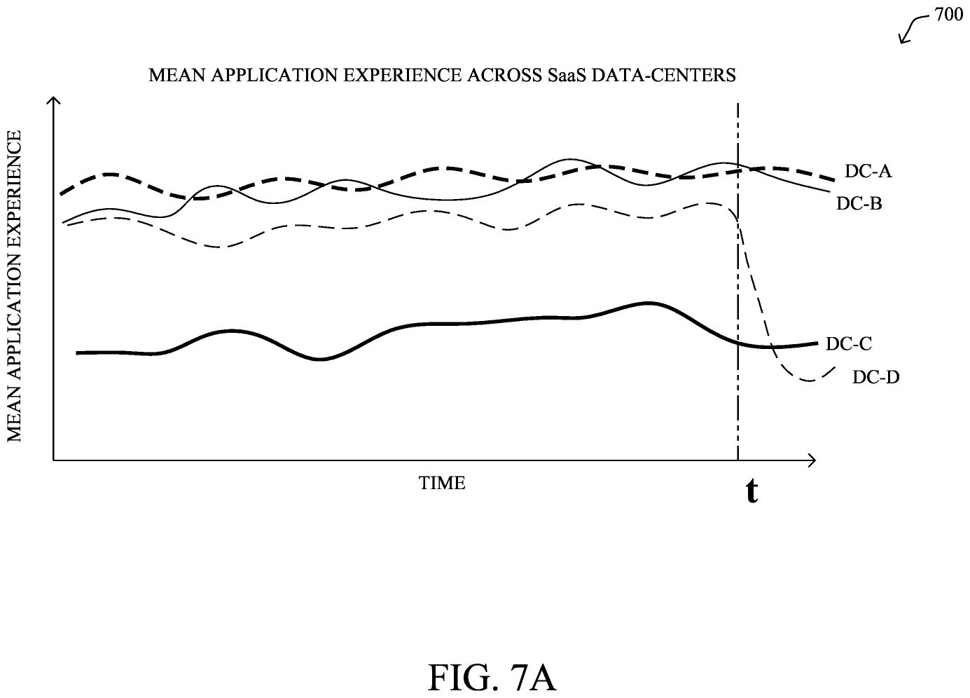

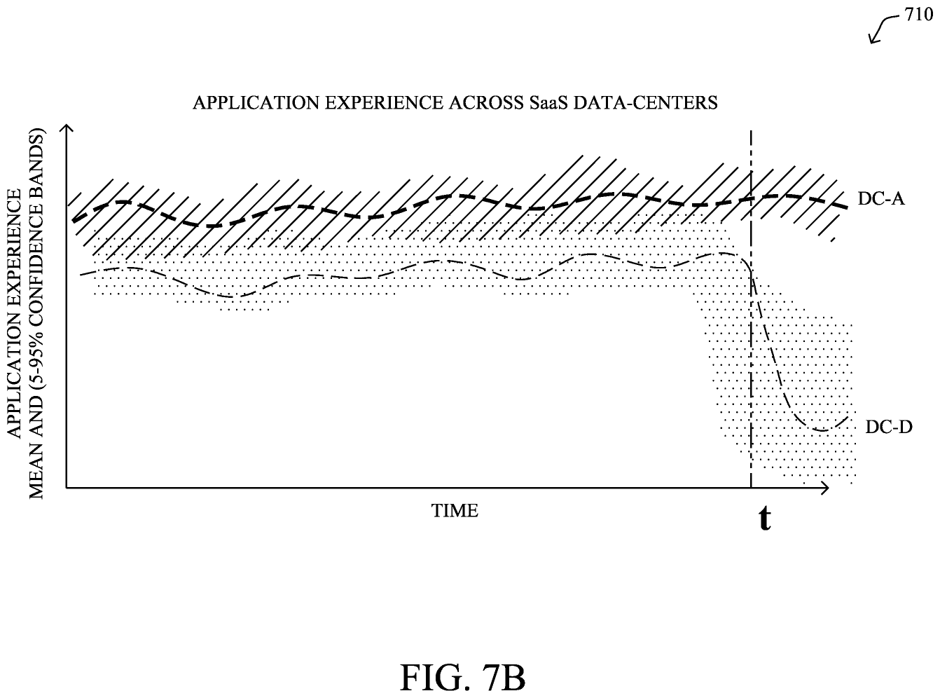

For example, consider plot 700 in FIG. 7A of mean application experience across a set of SaaS data centers over time: DC-A, DC-B, DC-C, and DC-D. Here, the application experience metric may be on a range from 1-5, such as a mean opinion score (MOS) for voice. From this, VPME 504 can construct the time series shown for the mean application experience for all of the different paths through a given instance of the vantage point (e.g., DC-A, DC-B, etc.). Similarly, plot 710 in FIG. 7B shows the time series of the distributions of the application experience metrics for DC-A and DC-D with 5% and 95% confidence intervals.

In various embodiments, VPME 504 may examine the time series from each vantage point, to check whether any paths for the data centers exhibit better application experience. For instance, in the scenarios presented in FIGS. 7A-7B, it can be seen that:
The mean application experience of DC-A and DC-B is always high, and the distribution in FIG. 7B also suggests that there is not much variability for DC-A.
The mean application experience of DC-C is always bad.
The mean application experience of DC-D was good until time ‘t,’ but suddenly drops after that. Also, the variation of the experience increases, as seen by the large confidence bands in FIG. 7B.

Referring again to FIG. 5, such temporal statistics of application experience can be used for purposes of root-causing. In another embodiment, VPME 504 may aggregate categorical application experiences (e.g., GOOD, DEGRADED, BAD) where such application-aware feedback may be provided by the SaaS application itself, such as through a direct application experience feedback loop mechanism. In such a case, VPME 504 may measure the frequency of each category for every time-period and for each vantage point.

In yet another embodiment, VPME 504 may measure not only distribution of application experiences, but also network QoS metrics such as loss, latency, jitter and bandwidth. In any or all of the above embodiments, VPME 504 may also summarize the distribution and other statistics for application experience and other QoS metrics for every time-period, and across every vantage point.

In various embodiments, SaaS root causing engine (SRCE) 506 may be responsible for determining whether the most probable cause of bad application experience is the SaaS endpoint (infrastructure or services such as the SaaS data center or server), itself.

In another embodiment, SRCE 506 may tag all application paths seen with a vantage point instance tuple, which is defined as the tuple of vantage point instances seen by that path. For instance, the vantage point instance tuple for the path shown in FIG. 6 may be as follows: Tₖ=<Site-S, City-C, SP-S, DestASN-IP1, DC-D, Server-S>. Across all the paths, the set of all possible combinations of vantage point tuples seen is defined as a vantage point instance set. This set can be used as a basis for estimating the most probable cause of bad experience metrics for the application. This can be done using any number of statistical, data mining, or machine learning approaches. In one instance, SRCE 506 may construct the distribution of application experience for each vantage point instance tuple Tk, referred to as FTk. SRCE 506 may then infer which vantage point is the most probable to be the cause of the bad application experience by comparing the distribution FTk with the distribution of application experiences for each individual vantage point.

For example, let Ij be an instance (e.g., Ij may be for DC-D) having a distribution FIj. In such a case, SRCE 506 may compare the similarity of FTi with FIj (the distribution of application experience for DC-D), such as by applying the Cramer-von Mises test to them. Doing so will provide a distance d(FTk, FIj) between the distributions, with the similarity between them increasing as this score decreases. The application experience of a tuple Tk can then be attributed to Ij using heuristics. For example, SRCE 506 may infer that Ij the is the probable cause of bad application experiences for all paths on tuple Tk if:
the application experience is bad: If the 75th percentile of application experience for FTk>certain threshold, AND
the distance is less than another threshold

In another embodiment, SRCE 506 may use an association mining algorithm to infer which instance is the cause for bad application quality. In this scenario, all tuples FTk with bad experience can be included in a set. Association mining can then be performed by SRCE 506 to check whether any SaaS endpoint (e.g., a data-center DC-X or a SaaS server Server-Y) has a large support. Larger support implies a greater chance that this SaaS endpoint is most often seen in the set of all tuples with bad experiences. Some instances may also be prevalent in the entire vantage point instance set (e.g., there may be only one SaaS data-center present, in which case all paths will be using such a data-center). In such cases, SRCE 506 may normalize the support of an instance by how often it is seen in the vantage point instance set.

In yet another embodiment, SRCE 506 may exclude or replace certain instances in tuples, to check whether removing a certain SaaS endpoint would have provided better application experience. For example, in the case of FIG. 6, SRCE 506 may compare the distribution FTk of Tₖ=<Site-S, City-C, SP-S, DestASN-IP1, DC-D, Server-S> with another distribution FTk′ which consists of all tuples T_{k′}=<Site-S, City-C, SP-S, DestASN-IP1, DC-D, *>. SRCE 506 can then use distribution comparison methods such as Cramer-von Mises or Kullback-Leibler (KL) divergence to check if the distribution is significantly different (and worse). If so, SRCE 506 may attribute the Server-S attributed as the probable cause for bad application experience.

Degradation analysis process 249 may also include endpoint failure announce (EFA) 508 which is responsible for tracking the sudden changes in application experience for SaaS instances, and informing the downstream applications such as a predictive routing engine (e.g., predictive routing process 248) and/or the SaaS application about the possible deterioration of the application experience associated with a particular SaaS endpoint.

In one embodiment, EFA 508 may monitor the mean (or any suitable statistic) of the application experience metrics. If there is a sudden drop in the application experience for one SaaS endpoint (e.g., one server or data center), but not for other SaaS endpoints, EFA 508 may send a message to the predictive routing engine that a particular instance of SaaS endpoint has experienced a sudden deterioration. In yet another embodiment, such message can be used to cause an end client to reroute traffic destined to a given application to a different data center. Such an alert/notification could be sent directly by EFA 508, or indirectly, in which case the application manager could decide what is the the most appropriate decisions. For example, consider the case of voice calls in a given region distributed across multiple DCs. Applications would be typically aware of degraded quality of experience (bad MoS) without being aware that the root cause is the data center itself. Upon receiving the alert from EFA 508 indicating that the root cause lies in a given data center as observed by VPME 504, the application may then decide to redirect all voice calls to another data center for the said region, still in purely reacted mode.

In another embodiment, EFA 508 may perform a peer-based clustering of SaaS endpoints, to group all SaaS endpoints with similar experience metrics over the last n-number of months. An endpoint is assumed to have deteriorated if the relative drop in the application experience is higher. Such a peer-based health detection will avoid tagging all the servers in a data center as the cause of bad application experience if, for example, a data center itself has problems.

In other words, EFA 508 may send a custom alert/notification to the routing engine and/or to the SaaS application provider, if a sudden change in application experience metrics is observed. As with all anomaly detection mechanisms, the root causing must be exposed to the end user (the client) in order to trigger a reroute, to the predictive engine (when such an engine exist) to adapt predictive decisions, or to the application manager.

A final potential component of degradation analysis process 249 is SaaS rerouter 510, which may be implemented as part of degradation analysis process 249 or, alternatively, as part of predictive routing process 248. In general, SaaS rerouter 510 is responsible for dynamically re-routing the traffic from a ‘bad’ SaaS endpoint to a better SaaS endpoint. In one embodiment, SaaS rerouter 510 will receive messages from SRCE 506 or EFA 508. For all new sessions which perform DNS resolution for the SaaS traffic, SaaS rerouter 510 may block propagating the SaaS server if it is known to provide bad application experience. SaaS rerouter 510 may also only propagate a SaaS server with a better application experience, if one exists.

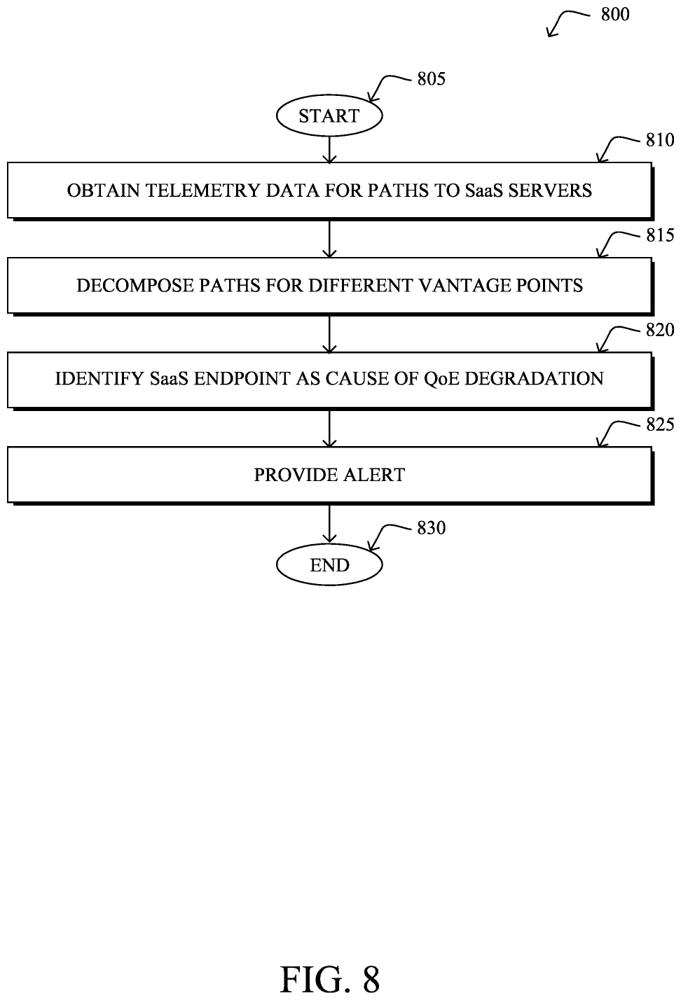

FIG. 8 illustrates an example simplified procedure 800 (e.g., a method) procedure for identifying a SaaS endpoint as the root-cause of degraded application performance, in accordance with one or more embodiments described herein. For example, a non-generic, specifically configured device (e.g., device 200), such as controller for a network (e.g., an SDN controller or other device in communication therewith), may perform procedure 800 by executing stored instructions (e.g., degradation analysis process 249), to provide a supervisory service to a network. The procedure 800 may start at step 805, and continues to step 810, where, as described in greater detail above, the device may obtain telemetry data for network paths to a plurality of servers for an online application, such as a SaaS application. In various embodiments, the telemetry data may include application experience metrics based on feedback provided by users of the online application. In further embodiments, the telemetry data may also include information that the device can use to decompose the paths to the different servers from different vantage points, such as geographic regions, service providers, destination autonomous systems, data centers for the online application, or the like.

At step 815, as detailed above, the device may decompose the telemetry data for the network paths from different vantage points. For instance, the device may identify the different sites, geographic regions, service providers, destination ASNs, or the like, that are traversed by the paths to the servers of the online application. In some embodiments, the device may also generate time series for the different decompositions, such as time series of the application experience metrics (e.g., mean application experience scores, distributions of the experience scores, etc.).

At step 820, the device may identify, using the decomposed telemetry data, a particular endpoint of the online application as a cause of application experience degradation for the online application, as described in greater detail above. For instance, in various embodiments, the device may identify a particular data center or server of the online application as being the root cause of the experience metrics being degraded for some users. In one embodiment, the device may do so in part by comparing time series of the application experience metrics from the different vantage points and identifying one of them associated with the particular endpoint as anomalous.

At step 820, as detailed above, the device may provide an alert indicative of the particular endpoint of the online application being the cause of quality of experience degradation for the online application. In one embodiment, the device may provide the alert to an application-aware routing engine that routes traffic for the online application away from the particular endpoint based on the alert. Such a routing engine may be hosted by the device or located remotely. In another embodiment, the device may provide the alert to a client of the online application and the client accesses a different endpoint of the online application based on the alert. In a further embodiment, the device may provide the alert to a provider of the online application. Doing so may prompt the provider to modify DNS listings for the application, etc., to direct traffic away from the offending endpoint. Procedure 800 then ends at step 830.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow for the identification of SaaS and other online application endpoints that are responsible for degraded application performance from the standpoint of its users. In some aspects, this allows for corrective measures to be taken, such as by having an application-aware routing engine route application traffic to a different endpoint for the application.

While there have been shown and described illustrative embodiments that provide for root-causing SaaS endpoints for network issues in application-driven predictive routing, it is to be understood that various other adaptations and modifications may be made within the spirit and scope of the embodiments herein. For example, while certain embodiments are described herein with respect to using certain models for purposes of predicting application experience metrics, SLA violations, or other disruptions in a network, the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
obtaining, by a device, telemetry data for network paths to a plurality of servers for an online application, wherein the telemetry data comprises application experience metrics based on feedback provided via a user interface by users of the online application;
decomposing, by the device, the telemetry data for the network paths from different vantage points;
identifying, using the telemetry data decomposed by the device, a particular endpoint of the online application as a cause of application experience degradation for the online application; and
providing, by the device, an alert indicative of the particular endpoint of the online application being the cause of quality of experience degradation for the online application, wherein the device provides the alert to an application-aware routing engine that routes traffic for the online application away from the particular endpoint based on the alert.

2. The method as in claim 1, wherein the online application is a software as a service (SaaS) application.

3. The method as in claim 1, further comprising:
identifying the different vantage points using the telemetry data.

4. The method as in claim 1, wherein the particular endpoint comprises a data center.

5. (canceled)

6. The method as in claim 1, wherein identifying the particular endpoint of the online application as the cause of application experience degradation for the online application comprises:
comparing time series of the application experience metrics from the different vantage points and identifying one of them associated with the particular endpoint as anomalous.

7. The method as in claim 1, wherein the device provides the alert to a client of the online application and the client accesses a different endpoint of the online application based on the alert.

8. The method as in claim 1, wherein the different vantage points comprise at least one of: service providers, destination autonomous systems, or data centers.

9. The method as in claim 1, wherein the device provides the alert to a provider of the online application.

10. The method as in claim 1, wherein the feedback is provided via the user interface by the users of the online application during or after their use of the online application.

11. An apparatus, comprising:
one or more network interfaces;
a processor coupled to the one or more network interfaces and configured to execute one or more processes; and
a memory configured to store a process that is executable by the processor, the process when executed configured to:
obtain telemetry data for network paths to a plurality of servers for an online application, wherein the telemetry data comprises application experience metrics based on feedback provided via a user interface by users of the online application;
decompose the telemetry data for the network paths from different vantage points;
identify, using the telemetry data decomposed by the apparatus, a particular endpoint of the online application as a cause of application experience degradation for the online application; and
provide an alert indicative of the particular endpoint of the online application being the cause of quality of experience degradation for the online application, wherein the device provides the alert to an application-aware routing engine that routes traffic for the online application away from the particular endpoint based on the alert.

12. The apparatus as in claim 11, wherein the online application is a software as a service (SaaS) application.

13. The apparatus as in claim 11, wherein the process when executed is further configured to:
identify the different vantage points using the telemetry data.

14. The apparatus as in claim 11, wherein the particular endpoint comprises a data center.

15. (canceled)

16. The apparatus as in claim 11, wherein the apparatus identifies the particular endpoint of the online application as the cause of application experience degradation for the online application by:
comparing time series of the application experience metrics from the different vantage points and identifying one of them associated with the particular endpoint as anomalous.

17. The apparatus as in claim 11, wherein the apparatus provides the alert to a client of the online application and the client accesses a different endpoint of the online application based on the alert.

18. The apparatus as in claim 11, wherein the different vantage points comprise at least one of: service providers, destination autonomous systems, or data centers.

19. The apparatus as in claim 11, wherein the apparatus provides the alert to a provider of the online application.

20. A tangible, non-transitory, computer-readable medium storing program instructions that cause a device to execute a process comprising:
obtaining, by the device, telemetry data for network paths to a plurality of servers for an online application, wherein the telemetry data comprises application experience metrics based on feedback provided via a user interface by users of the online application;
decomposing, by the device, the telemetry data for the network paths from different vantage points;
identifying, using the telemetry data decomposed by the device, a particular endpoint of the online application as a cause of application experience degradation for the online application; and
providing, by the device, an alert indicative of the particular endpoint of the online application being the cause of quality of experience degradation for the online application, wherein the device provides the alert to an application-aware routing engine that routes traffic for the online application away from the particular endpoint based on the alert.
